(19) United States
(12) Patent Application Publication
(10) Pub. No.: US 2011/0069976 A1
(43) Pub. Date: Mar. 24, 2011

(54) IMAGE FORMING APPARATUS, RECORDING MEDIUM TRANSPORTATION APPARATUS, RECORDING MEDIUM TRANSPORTATION METHOD AND COMPUTER READABLE MEDIUM

(75) Inventor: Toru OZAWA, Saitama-shi (JP)

(73) Assignee: FUJI XEROX CO., LTD., Tokyo (JP)

(21) Appl. No.: 12/761,723

(22) Filed: Apr. 16, 2010

(30) Foreign Application Priority Data
Sep. 18, 2009 (JP) 2009-217729

(51) Int. Cl. G03G 15/00

(52) U.S. Cl. 399/16

(57) ABSTRACT

An image forming apparatus includes: an image forming unit forming an image on a recording medium; a recording medium transportation unit transporting, along a transportation route, the recording medium on which the image has been formed by the image forming unit, and interrupting transportation operation for the recording medium in a state where one part of the recording medium is discharged from the transportation route and the other part of the recording medium is held in the transportation route; a detection unit detecting pull out operation by a user for the recording medium containing the other part held in the transportation route by the interruption of the transportation operation by the recording medium transportation unit; and a controller controlling the recording medium transportation unit so that the transportation operation having been interrupted is restarted, upon the detection of the pull out operation by the user by the detection unit.

### CROSS REFERENCE TO RELATED APPLICATIONS

This application is based on and claims priority under 35 USC §119 from Japanese Patent Application No. 2009-217729 filed Sep. 18, 2009.

### BACKGROUND

1. Technical Field

The present invention relates to an image forming apparatus, a recording medium transportation apparatus, a recording medium transportation method and a computer readable medium storing a program.

2. Related Art

In general, in image forming apparatuses such as copy machines, printers and the like, a recording medium on which image forming processing has been performed is immediately outputted to an outside of the apparatus, and is supplied to a user.

### SUMMARY

According to an aspect of the present invention, there is provided an image forming apparatus including: an image forming unit that forms an image on a recording medium; a recording medium transportation unit that transports, along a transportation route, the recording medium on which the image has been formed by the image forming unit, and that interrupts transportation operation for the recording medium in a state where one part of the recording medium is discharged from the transportation route and the other part of the recording medium is held in the transportation route; a detection unit that detects pull out operation by a user for the recording medium containing the other part held in the transportation route by the interruption of the transportation operation by the recording medium transportation unit; and a controller that controls the recording medium transportation unit so that the transportation operation having been interrupted is restarted, upon the detection of the pull out operation by the user by the detection unit.

### BRIEF DESCRIPTION OF THE DRAWINGS

Exemplary embodiments of the present invention will be described in detail based on the following figures, wherein:

FIG. 1 shows a configuration of an image forming apparatus to which the first exemplary embodiment is applied;

FIG. 2 is a view showing the configuration of the sheet transportation mechanism according to the first exemplary embodiment;

FIGS. 3A and 3B are views for explaining the configuration of the sheet discharge mechanism part;

FIGS. 4-1 and 4-2 are flowcharts showing an example of the contents of the sheet transportation control for the sheet transportation mechanism, performed by the main controller;

FIG. 5 is a view showing the position of the sheet at the time point when the main controller restarts the operation of the sheet transportation mechanism;

FIG. 6 is a block diagram showing an internal configuration of the main controller; and

FIG. 7 is a view showing the configuration of the sheet transportation mechanism according to the second exemplary embodiment.

### DETAILED DESCRIPTION

Hereinafter, exemplary embodiments of the present invention will be described in detail with reference to the attached drawings.

### First Exemplary Embodiment

### Description of Entire Configuration of Image Forming Apparatus

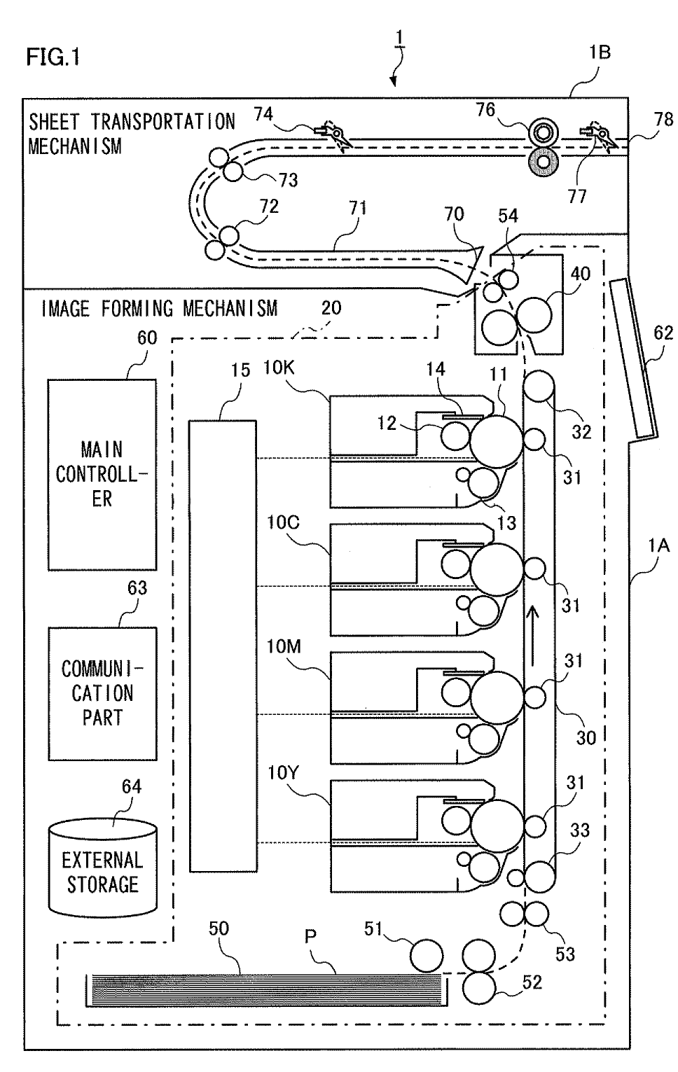

FIG. 1 shows a configuration of an image forming apparatus 1 to which the first exemplary embodiment is applied. The image forming apparatus 1 shown in FIG. 1 is a color printer employing an electrophotographic method, and includes an image forming mechanism 1A that forms a color image on a recording medium (sheet) P on the basis of image data, and a sheet transportation mechanism 1B that transports the sheet P on which the color image has been formed by the image forming mechanism 1A to the outside.

The image forming apparatus 1 according to the first exemplary embodiment is different from one installed in a place such as a general office or the like where users are limited to a specific kind of people. It is assumed that the image forming apparatus 1 is installed, for example, at an aisle or along a wall in a public facility such as a station, an airport or the like where a large number of unspecified users access. Thus, the image forming apparatus 1 according to the first exemplary embodiment employs a mechanism for reducing an occurrence of breakdown caused by a user action, an occurrence that the sheet P on which the image has been formed is left as garbage, and the like, as will be described below.

### <Description of Configuration of Image Forming Mechanism>

The image forming mechanism 1A includes an image forming part 20, serving as an example of an image forming unit, which forms a color image on the sheet P, a main controller 60, serving as an example of a controller, which performs operation control of the entire image forming apparatus 1 (the image forming mechanism 1A and the sheet transportation mechanism 1B) and information processing such as image processing and the like, and an operation display panel 62 that is arranged on a front side of the image forming apparatus 1 (a side located on the right side of FIG. 1), that receives an operation input by a user and that displays various kinds of information for the user. Further, the image forming mechanism 1A includes a communication part 63 that is connected to, for example, a database (not shown in the figure) or the like installed in the outside, through a communication line, and that sends and receives information to and from the database or the like, and an external storage 64 in which processing programs and various kinds of information such as image information and the like are stored.

The image forming part 20 of the image forming mechanism 1A includes four image formation units 10Y, 10M, 10C and 10K (hereinafter, referred to as “image formation units 10”) which form a yellow (Y) toner image, a magenta (M) toner image, a cyan (C) toner image, and a black (K) toner image, respectively. These image formation units 10 are arranged in parallel at certain intervals in an up-and-down direction (substantially vertical direction), and each include a photoconductive drum 11 as an image carrier, a charging device 12 that charges a surface of the photoconductive drum 11, a developing device 13 that develops an electrostatic latent image formed on the photoconductive drum 11 with each color toner, and a cleaning unit 14 that cleans the surface of the photoconductive drum 11 after transfer.

Further, the image forming part 20 includes a laser exposure device 15 which exposes the photoconductive drums 11 arranged in the respective image formation units 10 on the basis of the respective color image datasets, and a sheet transportation belt 30 that transports the sheet P while being in contact with the photoconductive drums 11 of the image formation units 10. The sheet transportation belt 30 is formed by a film-shaped endless belt that electrostatically attracts the sheet P. In addition, the sheet transportation belt 30 is stretched and held by a drive roll 32 and an idle roll 33 and cyclically moves. Further, the sheet transportation belt 30 transports the sheet P between the sheet transportation belt 30 and the photoconductive drums 11 from the lower side toward the upper side in approximately the vertical direction (arrow direction in FIG. 1).

Furthermore, the image forming part 20 includes transfer rolls 31 which are located inside the sheet transportation belt 30 and at positions facing the corresponding photoconductive drums 11. The transfer rolls 31 sequentially transfer the respective color toner images formed by the image formation units 10, on the sheet P to be transported while being held by the sheet transportation belt 30.

Still furthermore, the image forming part 20 includes a fixing device 40 on a downstream side of the sheet transportation belt 30 in the sheet transportation direction. Here, the fixing device 40 performs fixing processing for an unfixed toner image on the sheet P with heat and pressure. Moreover, the image forming part 20 includes a sheet output roll 54 on a downstream side of the fixing device 40 in the sheet transportation direction. Here, the sheet output roll 54 sends the sheet P subjected to the fixing processing by the fixing device 40 to the sheet transportation mechanism 1B.

In addition, the image forming part 20 includes a sheet container 50 that contains sheets P, a pick-up roll 51 that feeds the sheet P contained in this sheet container 50, a transportation roll 52 that transports the sheet P fed by the pick-up roll 51, and a resist roll 53 that sends the sheet P to the sheet transportation belt 30 in accordance with the image forming operation. Here, the sheet container 50, the pick-up roll 51, the transportation roll 52 and the resist roll 53 are located on an upstream side of the sheet transportation belt 30 in the sheet transportation direction.

### <Description of Operation of Image Forming Mechanism>

When the image forming mechanism 1A according to the first exemplary embodiment receives an operation input by a user through the operation display panel 62, the main controller 60 analyses contents of the instruction inputted by the user. Then, the main controller 60 transmits a transmission request on information corresponding to the contents of the instruction by the user to, for example, the database (not shown in the figure) installed in the outside, through the communication part 63. Upon receiving, from the database to the communication part 63, the information for which the transmission request has been made, the main controller 60 performs processing such as image processing or the like for the received information, and generates respective color image datasets. Then, the main controller 60 outputs the respective color image datasets thus generated, to the laser exposure device 15. By this operation, the laser exposure device 15 exposes the photoconductive drums 11 of the image formation units 10 on the basis of the respective color image datasets, and thereby respective color toner images of Y, M, C and K are formed in the image formation units 10.

When the respective color toner images are started to be formed in the image formation units 10, the sheet P is picked up from the sheet container 50. Then, the sheet P is transported to the resist roll 53 by the transportation roll 52, and is supplied to the sheet transportation belt 30 by the resist roll 53 in accordance with the timing when the toner images are formed. The sheet transportation belt 30 holds and transports the sheet P. During this operation, the respective color toner images are sequentially transferred onto the sheet P, by using transfer electric fields formed by the transfer rolls 31.

The sheet P on which the color toner images have been electrostatically transferred is separated from the sheet transportation belt 30 at a downstream position of the image formation unit 10K, and is transported to the fixing device 40. When the sheet P is transported to the fixing device 40, the unfixed toner image on the sheet P is fixed on the sheet P. Thereafter, the sheet P on which the color toner images have been fixed is sent to the sheet transportation mechanism 1B from the sheet output roll 54.

### <Description of Configuration of Sheet Transportation Mechanism>

The sheet transportation mechanism 1B includes a sheet transportation route 71 that receives the sheet P sent from the sheet output roll 54 of the image forming mechanism 1A at a receiving port 70 and that guides the sheet P to an output port 78 arranged on the front side of the image forming apparatus 1 (the side located on the right side of FIG. 1), transportation rolls 72 and 73 that transport the sheet P in the sheet transportation route 71, and a first sheet passage detection part 74 serving as an example of a detection unit (second detection unit) and a second sheet passage detection part 77 serving as an example of a detection unit (first detection unit), which detect the passage of the sheet P and are arranged at positions set in advance on the sheet transportation route 71, respectively. Further, the sheet transportation mechanism 1B includes a sheet discharge mechanism part 76, serving as a recording medium transportation unit, which transports the sheet P sent by the transportation rolls 72 and 73 and discharges the sheet P being in the stopped state in the sheet transportation route 71 from the output port 78.

The first sheet passage detection part 74 and the second sheet passage detection part 77 are each configured of an actuator swinging by contact with the sheet P and a light detection part that detects the swing of the actuator through shielding or transmission of light by a light shielded part provided in the actuator. By this configuration, the first sheet passage detection part 74 and the second sheet passage detection part 77 each detect that the top end S and the back end T of the sheet P pass therethrough, through a change from the transmission of the light to the shielding of the light and a change from the shielding of the light to the transmission of the light, by use of the light detection part.

The first sheet passage detection part 74 is arranged on a downstream side of the transportation roll 73, and on an upstream side of the sheet discharge mechanism part 76 in the sheet transportation direction on the sheet transportation route 71. The second sheet passage detection part 77 is arranged on the downstream side of the sheet discharge mechanism part 76 and on an upstream side of the output port 78 in the sheet transportation direction.

### <Description of Operation of Sheet Transportation Mechanism>

When receiving the sheet P on which the image has been formed in the image forming mechanism 1A, the sheet transportation mechanism 1B according to the first exemplary embodiment transports the sheet P toward the output port 78 by use of the transportation rolls 72 and 73 and the sheet discharge mechanism part 76. Then, when the sheet P arrives at a position where the top end S thereof is discharged from the output port 78 of the sheet transportation mechanism 1B by a predetermined length, the transportation rolls 72 and 73 and the sheet discharge mechanism part 76 are stopped once, and the sheet transportation operation is interrupted. Thereafter, if the sheet P in a stopped state, which has one part discharged from the sheet transportation route 71 (the output port 78) and the other part held in the sheet transportation route 71, is pulled out by a user, this pull out operation is detected by the first sheet passage detection part 74 serving as an example of the detection unit that detects the pull out operation for the sheet P (recording medium) by the user. Thereby, the sheet discharge mechanism part 76 restarts the transportation operation for the sheet P. After that, the second sheet passage detection part 77 detects that the back end T of the sheet P is discharged from the output port 78, and thereby the sheet discharge mechanism part 76 finishes the sheet transportation operation.

### <Description of Interruption Processing for Sheet Transportation Operation in Sheet Transportation Mechanism>

As mentioned above, it is assumed that the image forming apparatus 1 according to the first exemplary embodiment is used by unspecified users. Accordingly, the sheet transportation mechanism 1B outputs the sheet P on which the image has been formed, after the user is ready to receive the sheet P so that the user may receive the sheet P more securely, instead of outputting the sheet P to the outside immediately. Thus, the sheet transportation mechanism 1B stops the sheet P (interrupts the output operation) once at a position so that the top end S of the sheet P is discharged from the output port 78 of the sheet transportation mechanism 1B by the predetermined length. Then, the sheet transportation mechanism 1B discharges the entire sheet P to the outside after confirming that the user intends to pull out the sheet P being in a state where only the one part thereof on the top end S side is outputted from the output port 78 and indicates his/her intention to receive the sheet P on which the image has been formed. Thereby, for example, in a case where the user's hands are full of bags or the like and the user is unable to immediately receive the sheet P, the sheet P is held in the sheet transportation mechanism 1B, and the sheet transportation mechanism 1B waits until the user is ready to receive the sheet P. Accordingly, an occurrence that the sheet P on which the image has been formed is dropped onto, for example, a floor and the sheet P ends up in garbage or the like is reduced.

In a case where the sheet P is stopped once in the sheet transportation mechanism 1B, the main controller 60 of the image forming mechanism 1A measures time from the time point when the top end S of the sheet P passes through the second sheet passage detection part 77. Then, the main controller 60 calculates the moving amount of the sheet P from the measured time and the sheet transportation speed set by the transportation rolls 72 and 73 and the sheet discharge mechanism part 76. Further, the main controller 60 recognizes the time point when the top end S of the sheet P is discharged from the output port 78 by the predetermined length, on the basis of the calculated moving amount of the sheet P, and stops the driving of the transportation rolls 72 and 73 and the sheet discharge mechanism part 76 at this time point.

Note that, as “the predetermined length from the output port 78,” the length of the sheet P easily to be taken by a user is referred to. For example, the length of approximately 5 cm to 15 cm from the output port 78 (the length in the sheet P) is set.

### <Description of Sheet Pull-Out Mechanism>

Next, a description will be given of a mechanism for enabling the user to pull out the sheet P being in the stopped state in the sheet transportation route 71, in the sheet transportation mechanism 1B.

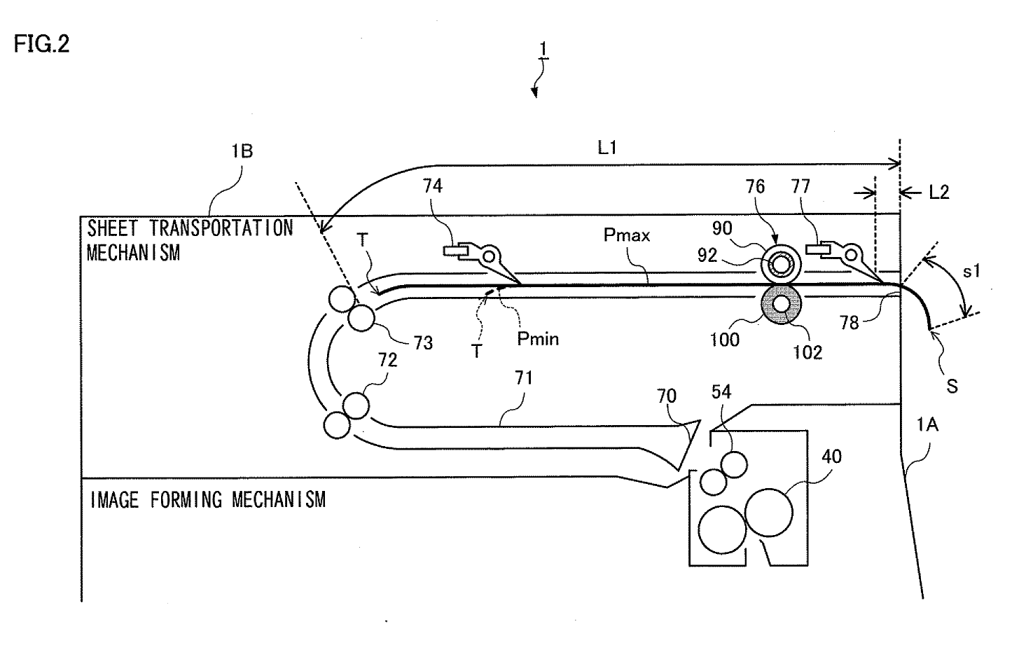

FIG. 2 is a view showing the configuration of the sheet transportation mechanism 1B according to the first exemplary embodiment. As shown in FIG. 2, in the sheet transportation mechanism 1B according to the first exemplary embodiment, transportation length L1 from the transportation roll 73 to the output roll 78 in the sheet transportation route 71 is set so that the user may pull out any size of the sheet P. In other words, the transportation length L1 is set so that the back end T of a sheet Pmax having maximum length usable in the image forming mechanism 1A is located on the downstream side of the transportation roll 73 in the transportation direction when the sheet Pmax is stopped in a state where the top end S of the sheet Pmax is discharged from the output port 78 by a predetermined length s1.

By this setting, in a case where the sheet P is in the stopped state, the sheet P is held only by the sheet discharge mechanism part 76 regardless of the size of the sheet P usable in the image forming mechanism 1A, and is not held by the transportation rolls 72 and 73.

The first sheet passage detection part 74 is arranged so as to detect that the user pulls out the sheet P regardless of the size of the sheet P. Specifically, the first sheet passage detection part 74 is arranged so as to be located on the downstream side of a back end T of a sheet Pmin having minimum length usable in the image forming mechanism 1A in the transportation direction when the sheet Pmin is stopped in a state where a top end S of the sheet Pmin is discharged from the output port 78 by the predetermined length s1. Thus, in a case where the sheet P with any size is pulled out by the user, passage of the back end T of the sheet P through the first sheet passage detection part 74 is detected.

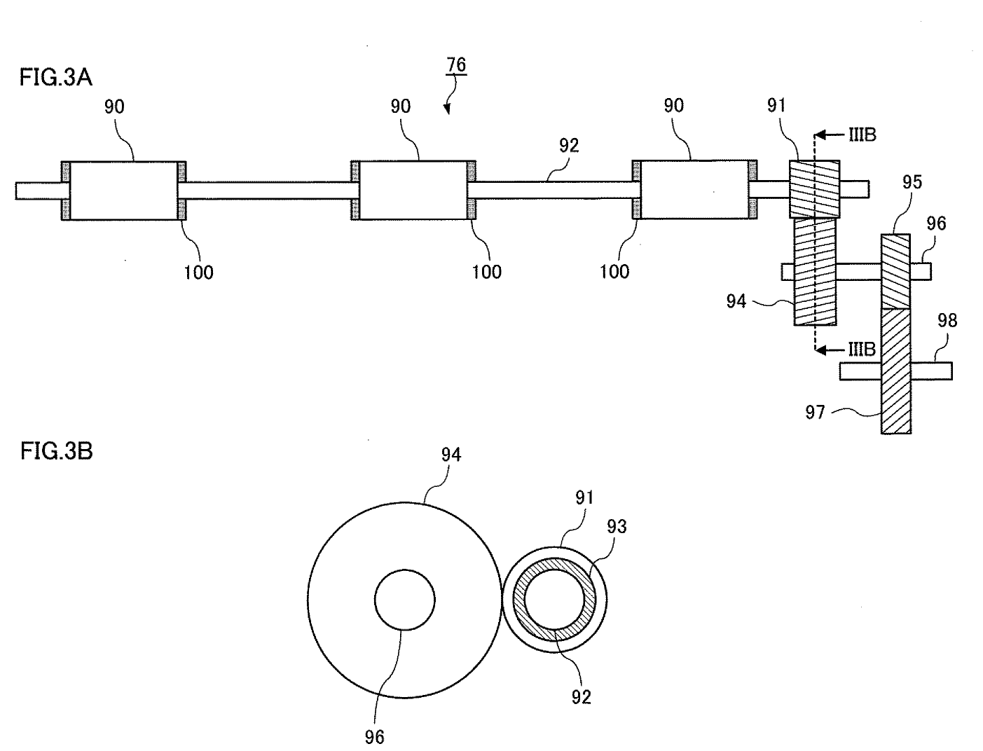

Next, FIGS. 3A and 3B are views for explaining the configuration of the sheet discharge mechanism part 76. Here, FIG. 3A is a plan view showing the entire configuration of the sheet discharge mechanism part 76, and FIG. 3B is a cross-sectional view of FIG. 3A taken along a line IIIB-IIIB.

First, as shown in FIG. 3A, the sheet discharge mechanism part 76 includes plural discharge rolls 90 and 100 fixed to rotation axes 92 and 102, respectively. Here, the plural discharge rolls 90 and 100 discharges the sheet P toward the output port 78 (also see FIG. 2, and the rotation axis 102 is not shown in FIG. 3A or 3B since the rotation axis 102 is hidden by the rotation axis 92). Both of these rotation axes 92 and 102 are rotatably supported by the housing of the main body of the sheet transportation mechanism 1B. Here, the discharge rolls 90 serves as an example of a transportation member.

On one end side of the rotation axis 92, a drive transmission gear 91 is fixed. The drive transmission gear 91 is connected to a gear 94 fixed to a rotation axis 96 arranged in parallel to the rotation axis 92, so as to be engaged with the gear 94. To the rotation axis 96, a gear 95 is also fixed. The gear 95 is connected to a gear 97 fixed to a rotation axis 98 to which the rotation drive force is transmitted from the drive motor (not shown in the figure), so as to be engaged with the gear 97. Therefore, in the sheet discharge mechanism part 76, the rotation drive force from the drive motor is transmitted by using a route from the rotation axis 98 to the discharge rolls 90 via the gear 97, the gear 95, the rotation axis 96, the gear 94, the drive transmission gear 91, and the rotation axis 92. In this configuration, the drive force is not directly applied on the discharge rolls 100, and thus the discharge rolls 100 are driven by the discharge rolls 90 to rotate.

As mentioned above, in a case where the drive motor operates, the rotation drive force of the drive motor rotates the discharge rolls 90, and the sheet P is transported toward the output port 78 by the discharge rolls 90 driven to be rotated and the discharge rolls 100 driven by the discharge rolls 90.

As shown in FIG. 3B, a one-way clutch 93, serving as an example of a force transmission restricting member, is arranged between the drive transmission gear 91 and the rotation axis 92. Here, the one-way clutch 93 is coaxial with the rotation axis 92. The one-way clutch 93 transmits, to the rotation axis 92, the rotation torque received by the drive transmission gear 91 from the gear 94. On the other hand, the one-way clutch 93 does not transmit the rotation torque from the rotation axis 92 in the same rotational direction to the drive transmission gear 91. Thereby, even if the driving of the drive motor is stopped and the high rotation torque is applied on the drive transmission gear 91 due to the connection and engagement between the drive transmission gear 91 and the gear 94, the rotation axis 92 (specifically, the discharge rolls 90 and 100) rotates in a low load condition by an effect of the one-way clutch 93 in a case where the user intends to pull out the sheet P. Thus, the user may pull out the sheet P with relatively small force.

### <Description of the Sheet Sending Operation>

A description will be given of sending operation for the sheet P performed by the sheet transportation mechanism 1B in a case where the user starts to pull out the sheet P being in the stopped state in the sheet transportation route 71.

Upon the start of pulling out the sheet P being in the stopped state in the sheet transportation route 71 by the user and the detection of the passage of the back end T of the sheet P by the first sheet passage detection part 74, the sheet discharge mechanism part 76 restarts the rotation of the discharge rolls 90 and 100 to send the sheet P toward the output port 78.

Specifically, after the main controller 60 serving as an example of a controller and arranged in the image forming mechanism 1A interrupts the sheet transportation operation in the sheet transportation mechanism 1B, the main controller 60 drives the drive motor (not shown in the figure) that drives the discharge rolls 90 of the sheet discharge mechanism part 76 to rotate, again, in response to the detection of the passage of the back end T of the sheet P by the first sheet passage detection part 74. Then, upon the detection of the passage of the back end T of the sheet P by the second sheet passage detection part 77, the main controller 60 stops the drive motor after the passage of the time which is calculated from the sheet transportation speed set by the sheet discharge mechanism part 76 and the transportation length L2 (see FIG. 2) from the position of the second sheet passage detection part 77 to the output port 78 and which is required for the back end T of the sheet P to pass through the output port 78. Note that, in a case where the sheet P is continuously discharged after the above operation, the driving of the driving motor is continued.

In this case, the sheet transportation speed set by the sheet discharge mechanism part 76 may be set so as to be different from the sheet transportation speed (process speed) in the image forming mechanism 1A and the sheet transportation mechanism 1B at the time of image formation by the image forming mechanism 1A.

For example, in the image forming apparatus 1 in which the process speed of the image forming mechanism 1A is set to be high (such as the speed exceeding 300 mm/sec, for example), if the sheet P is discharged at the sheet transportation speed that is the same as the process speed of the image forming mechanism 1A, the sending speed for the sheet P is too fast, and thus it is difficult for the user to receive the sheet P. On the other hand, in the image forming apparatus 1 in which the process speed of the image forming mechanism 1A is set to be low (such as the speed not greater than 50 mm/sec, for example), if the sheet P is discharged at the sheet transportation speed that is the same as the process speed of the image forming mechanism 1A, the sending speed for the sheet P is too slow, and thus the user in a hurry may pull out the sheet P, in some cases.

In order that the user may easily receive the sheet P at the time when the sheet P is discharged from the output port 78 of the sheet transportation mechanism 1B, the sheet transportation speed set by the sheet discharge mechanism part 76 may be set so as to be different from the process speed of the image forming mechanism 1A.

On the other hand, in a case where the original process speed of the image forming mechanism 1A has the value (for example, 150 to 200 mm/sec) at which the user easily receives the sheet P discharged from the output port 78, the sheet transportation speed by the sheet discharge mechanism part 76 may be set to be the same as the process speed of the image forming mechanism 1A.

As mentioned above, in the image forming apparatus 1 according to the first exemplary embodiment, the sheet P in which the image has been formed by the image forming mechanism 1A is held once in the sheet transportation mechanism 1B. Then, the user starts to pull out the sheet P held in the sheet transportation mechanism 1B in order to indicate his/her intention to receive the sheet P. In response, the sheet transportation mechanism 1B restarts the transportation of the sheet P by using the sheet discharge mechanism part 76. Thereby, the sheet P is discharged from the image forming apparatus 1 at the time point when the user is ready to receive the sheet P. Thus, the occurrence that the user fails to receive the sheet P is reduced. Accordingly, the image forming apparatus 1, which is installed at an aisle or along a wall in a public facility or the like such as a station, an airport or the like where a large number of unspecified people access, and which has a main purpose of printing map information, shop information or the like that has been requested by a user, reduces inconvenience, such as a situation that the user fails to receive the sheet P on which the various kinds of information has been printed and the sheet P is dropped onto the floor and left and then the sheet P ends up in garbage.

In addition, after the user starts to pull out the sheet P, since the sheet P is discharged by the sheet transportation mechanism 1B, the sheet P is smoothly sent. Meanwhile, if the pull out operation of the entire sheet P is performed only by the user, the sheet P may be obliquely pulled out, in some cases. In this case, the sheet P may be torn. Further, since the part of the torn sheet P may remain in the sheet transportation route 71, transportation failure or jamming of the following sheet P may occur. In addition, although the one-way clutch 93 is provided, the sheet P is necessary to be pulled out while the sheet discharge mechanism part 76 is rotated. Thus, the user receives the load therefrom, although the volume of the load is not so large. Thereby, the pull out operation by the user may be unstable in some cases. To avoid this, after the user starts to pull out the sheet P, influence of the user's operation is eliminated by causing the sheet transportation mechanism 1B to transport the sheet P. Accordingly, the sheet P may be smoothly sent.

Alternatively, in the image forming apparatus 1 according to the first exemplary embodiment, in a case where one image is formed on multiple sheets P for multiple pages, the sheet P for the first page may be held once in the sheet transportation mechanism 1B. Then, upon the start of pulling out operation for the sheet P for the first page held in the sheet transportation mechanism 1B by the user, the sheets P for all of the pages on which the one image is formed may be discharged from the sheet discharge mechanism part 76. Thereby, the multiple sheets P on which the one image has been formed are discharged in a short period of time.

Also, in the image forming apparatus 1 according to the first exemplary embodiment, in a case where one image is formed on multiple sheets P for multiple pages, a piece of the one image is formed on the sheet P for the first page, and then the sheet P for the first page may be held once in the sheet transportation mechanism 1B. By the time the user starts to pull out the sheet P for the first page held in the sheet transportation mechanism 1B, the image formation for the subsequent pages is interrupted. Thereafter, upon the start of the pull out operation by the user for the sheet P for the first page held in the sheet transportation mechanism 1B, the image formation for the other pages may be performed, and the sheets P for the other pages may be discharged from the sheet discharge mechanism part 76. On the other hand, in a case where the user does not pull out the sheet P for the first page, the image formation for the following pages may be terminated. By this configuration, wasted image formation is suppressed. In addition, occurrence of paper jam due to the jamming of the sheet P in the sheet transportation route 71 is also suppressed.

Moreover, the image forming apparatus 1 according to the first exemplary embodiment has a setting in which the image is formed on the upper side (user's side) of the sheet P being in the state where only a part thereof on the top end S side is outputted from the output port 78. Thus, the user easily determines whether the user should pull out the sheet P or not.

### <Description of Contents of Sheet Transportation Control by Main Controller>

Next, a description will be given of the contents of the sheet transportation control in the sheet transportation mechanism 1B, performed by the main controller 60.

FIGS. 4-1 and 4-2 are flowcharts showing an example of the contents of the sheet transportation control for the sheet transportation mechanism 1B, performed by the main controller 60.

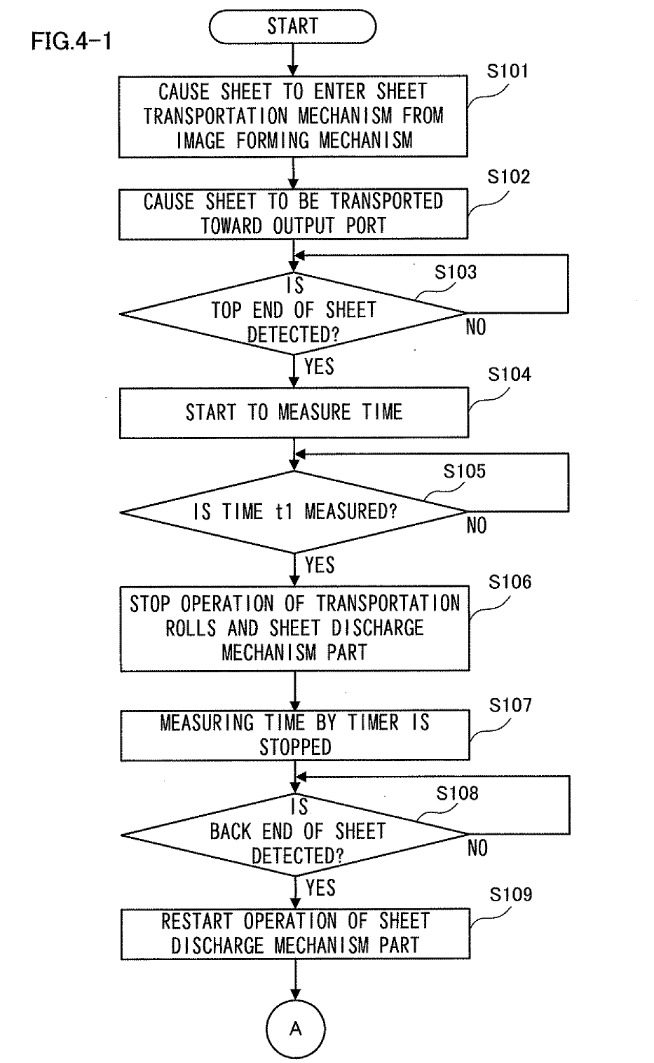

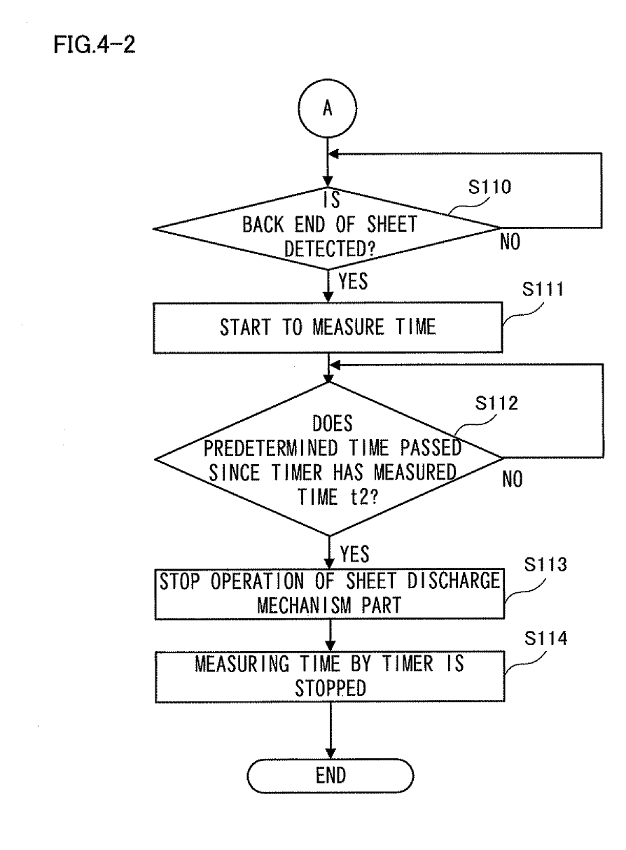

First, as shown in FIG. 4-1, the main controller 60 causes the sheet P on which the color image has been formed after completion of the image forming processing therefor in the image forming mechanism 1A, to enter the sheet transportation mechanism 1B from the image forming mechanism 1A (Step 101). Thereby, the main controller 60 operates the transportation rolls 72 and 73 and the sheet discharge mechanism part 76, and causes the sheet P to be transported toward the output port 78 (Step 102).

Thereafter, the main controller 60 waits for the second sheet passage detection part 77 as an example of the first detection unit to detect the top end S of the sheet P (No in Step 103). If the top end S of the sheet P is detected by the second sheet passage detection part 77 (Yes in Step 103), the main controller 60 acquires the detection information from the second sheet passage detection part 77, and thereby causing a timer (not shown in the figure) to start to measure time (Step 104). Then, at the time point when the timer measures the time t1 which is calculated from an additional value (L2+s1) and the sheet transportation speed set by the sheet transportation mechanism 1B, and which is required for the top end S of the sheet P to arrive at the position of the length s1 in the sheet P outputted from the output port 78 (Yes in Step 105), the operation of the transportation rolls 72 and 73 and the sheet discharge mechanism part 76 is stopped (Step 106). Here, L2 indicates transportation length from the position of the second sheet passage detection part 77 to the output port 78, while s1 indicates the predetermined length in the sheet P. Further, measuring time by the timer is stopped (Step 107). Note that, the position of the sheet P at the time point when the main controller 60 stops the operation of the transportation rolls 72 and 73 and the sheet discharge mechanism part 76 has been already shown in the above-described FIG. 2.

Meanwhile, before the timer measures the time t1 (No in Step 105), the operation of the transportation rolls 72 and 73 and the sheet discharge mechanism part 76 is continued, and also measuring time by the timer is continued.

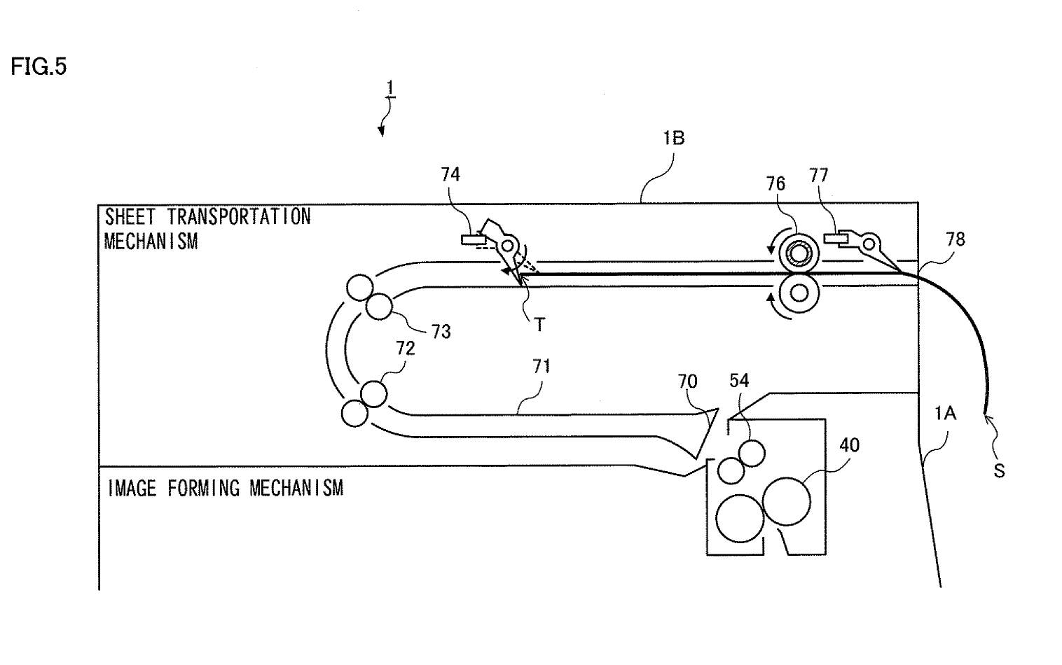

After that, the main controller 60 waits for the first sheet passage detection part 74 as an example of the second detection unit to detect the passage of the back end T of the sheet P through the pull out operation by the user for the sheet P (No in Step 108). If the first sheet passage detection part 74 detects the passage of the back end T of the sheet P (Yes in Step 108), the main controller 60 acquires detection information from the first sheet passage detection part 74, and thereby restarting the operation of the sheet discharge mechanism part 76 (Step 109). Here, FIG. 5 is a view showing the position of the sheet P at the time point when the main controller 60 restarts the operation of the sheet discharge mechanism part 76.

The flow proceeds to FIG. 4-2. After restarting the operation of the sheet discharge mechanism part 76, the main controller 60 waits for the second sheet passage detection part 77 to detect the back end T of the sheet P (No in Step 110). If the back end T of the sheet P is detected by the second sheet passage detection part 77 (Yes in Step 110), measuring time by the timer (not shown in the figure) is started (Step 111). Then, at the time point after the predetermined time passes since the timer has measured the time t2 which is calculated from the transportation length L2 (see FIG. 2) from the position of the second sheet passage detection part 77 to the output port 78 and the sheet transportation speed set by the sheet discharge mechanism part 76 and which is required for the back end T of the sheet P to pass through the output port 78 (Yes in Step 112), the operation of the sheet discharge mechanism part 76 is stopped (Step 113). Further, measuring time by the timer is also stopped (Step 114). Then, the main controller 60 finishes the sheet transportation control.

On the other hand, until the predetermined time passes after the timer measures the time t2 (No in Step 112), the operation of the sheet discharge mechanism part 76 is continued, and measuring time by the timer is also continued.

### <Description of Internal Configuration of Main Controller>

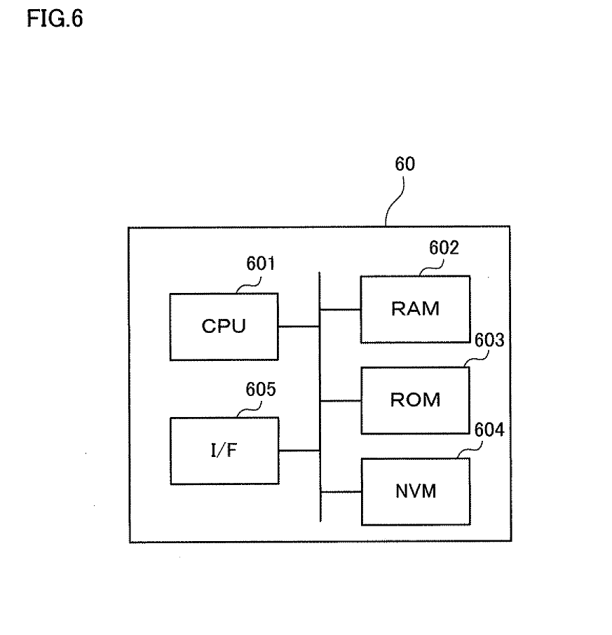

Next, FIG. 6 is a block diagram showing an internal configuration of the main controller 60. As shown in FIG. 6, the main controller 60 includes a CPU 601, a RAM 602, a ROM 603, a non-volatile memory (NVM) 604, and an interface (I/F) 605. The CPU 601 performs a digital arithmetic processing in accordance with a predetermined processing program for the execution of the sheet transportation control in the sheet transportation mechanism 1B. The RAM 602 is used as a working memory of the CPU 601. The ROM 603 stores various setting values to be used in the processing by the CPU 601. The NVM 604 is a battery-backed rewritable flash memory or the like capable of storing data even when power supply is lost. The I/F 605 controls an input and an output of a signal to and from respective functional units such as the motor driver (not shown in the figure) controlling the drive motor arranged in the sheet transportation mechanism 1B, the operation display panel 62, the communication part 63, the external storage 64 and the like arranged in the image forming mechanism 1A.

The CPU 601 loads the processing program from the external storage 64 into the main memory (RAM 602), and then implements respective functions in the main controller 60.

Note that, another mode of providing the processing program is to provide the processing program stored in advance in the ROM 603 and then load the processing program into the RAM 602. Still another way, if the rewritable ROM 603 such as an electrically erasable and programmable ROM (EEPROM) is included, is to install only the program into the ROM 603 after setting of the CPU 601, and then load the program into the RAM 602. Still another way is to transmit the program to the main controller 60 via a network such as the Internet, install the program into the ROM 603 of the main controller 60, and then load the program into the RAM 602. Even still another way is to load the program from an external recording medium such as a DVD-ROM or a flash memory into the RAM 602.

### [Second Exemplary Embodiment]

In the first exemplary embodiment, the description has been given of the configuration in which the sheet transportation speed of the sheet discharge mechanism part 76 discharging the sheet P held once in the sheet transportation mechanism 1B from the output port 78 is set at the predetermined speed. In the second exemplary embodiment, a description will be given of the configuration in which the sheet transportation speed of the sheet discharge mechanism part 76 is set in accordance with the speed at the time when the user pulls out the sheet P. Note that, the same components as those in the first exemplary embodiment are denoted by the same reference numerals, and the detailed description thereof will be omitted.

### <Description of Configuration of Sheet Transportation Mechanism>

The sheet transportation mechanism 1B according to the second exemplary embodiment includes a speed measurement unit that measures the pull out speed (moving speed) at the time when the user pulls out the sheet P held in the sheet transportation mechanism 1B, and a speed setting unit that sets the sheet transportation speed at the sheet discharge mechanism part 76 in accordance with the moving speed measured by the speed measurement unit, in addition to the configuration of the first exemplary embodiment.

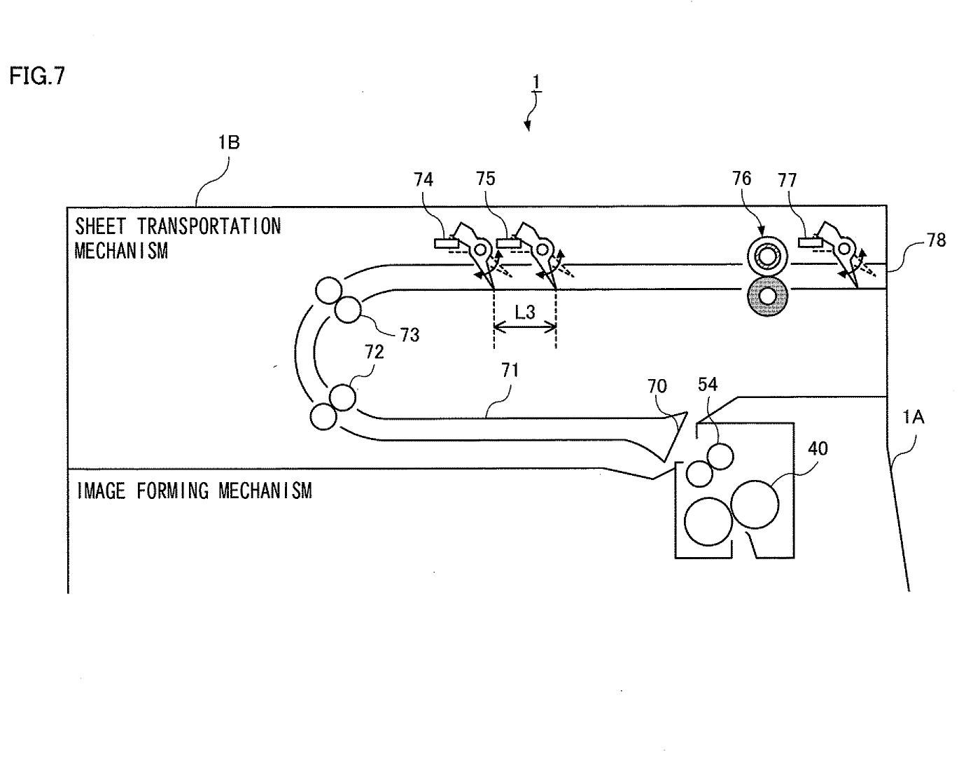

FIG. 7 is a view showing the configuration of the sheet transportation mechanism 1B according to the second exemplary embodiment. As shown in FIG. 7, the sheet transportation mechanism 1B according to the second exemplary embodiment includes a third sheet passage detection part 75, serving as an example of a speed measurement unit, which detects the passage of the sheet P, and which is located on the downstream side of the first sheet passage detection part 74 in the sheet transportation direction by a transportation length L3. The main controller 60 arranged in the image forming mechanism 1A (see FIG. 1) measures a time t3 for the third sheet passage detection part 75 to detect the passage of the back end T of the sheet P after the passage of the back end T of the sheet P is detected by the first sheet passage detection part 74 through the pull out operation by the user for the sheet P. Accordingly, the main controller 60 calculates the pull out speed at the time when the user pulls out the sheet P held in the sheet transportation mechanism 1B from the transportation length L3 from the position of the first sheet passage detection part 74 to the position of the third sheet passage detection part 75 and the time t3 for the back end T of the sheet P to pass through the third sheet passage detection part 75 after the back end T of the sheet P passes through the first sheet passage detection part 74.

The main controller 60, serving also as the speed setting unit, controls the motor driver (not shown in the figure) controlling the drive motor (not shown in the figure) driving the sheet discharge mechanism part 76 so that the sheet transportation speed at the sheet discharge mechanism part 76 is set as the calculated pull out speed of the user.

In this case, the main controller 60 may prepare, as the sheet transportation speed at the sheet discharge mechanism part 76, plural sheet transportation speeds in advance, and select one of them which is the closest to the calculated pull out speed of the user. In a case where the calculated pull out speed of the user is faster than the plural sheet transportation speeds prepared in advance, the fastest one among the plural sheet transportation speeds prepared in advance may be selected. On the other hand, in a case where the calculated pull out speed of the user is lower than the plural sheet transportation speeds prepared in advance, the lowest one among the plural sheet transportation speeds prepared in advance may be selected.

The main controller 60 may set both of the upper limit and lower limit of the sheet transportation speed for the sheet transportation speed at the sheet discharge mechanism part 76 in advance. In a case where the calculated pull out speed of the user is faster than the upper limit of the sheet transportation speed set in advance, the main controller 60 may select the upper limit of the sheet transportation speed. On the other hand, in a case where the calculated pull out speed of the user is lower than the lower limit of the sheet transportation speed set in advance, the main controller 60 may select the lower limit of the sheet transportation speed that has been set in advance.

In such a case, alternatively, by recognizing the tendency of the pull out speed of the user, any one of the upper limit and the lower limit of the sheet transportation speed may be set.

By this setting, the sheet discharge mechanism part 76 discharges the sheet P at the sheet transportation speed according to the pull out speed at the time when the user pulls out the sheet P. Thus, the sheet P is discharged at the speed according to the receiving capacity of the user in response to the pull out operation by the user at the speed for easily receiving the sheet P. Thus, it facilitates the reception of the sheet P by the user. In addition, by setting at least any one of the upper limit and lower limit of the sheet transportation speed at the sheet discharge mechanism part 76, an occurrence that the user drops the sheet P onto the floor because of the excessively high sheet transportation speed, an occurrence that the user pulls out the sheet P because of the excessively low sheet transportation speed or the like is reduced.

As the speed measurement unit, instead of the configuration using the first sheet passage detection part 74 and the third sheet passage detection part 75 as shown in the second exemplary embodiment, the configuration using the first sheet passage detection part 74, a mechanism that detects the rotation of the sheet discharge mechanism part 76, and size information on the sheet P used in the image formation may be employed.

Specifically, the main controller 60 recognizes the length of the sheet P in the transportation direction from the size information on the sheet P in advance, and calculates the transportation length between the back end T of the sheet P being in the stopped state in the sheet transportation route 71 and the position of the first sheet passage detection part 74. Upon the detection of the rotation of the sheet discharge mechanism part 76, measuring time by the timer is started, and the time for the back end T of the sheet P to pass through the first sheet passage detection part 74 is measured. Accordingly, the pull out speed at the time when the user pulls out the sheet P is calculated by use of the transportation length between the back end T of the sheet P and the position of the first sheet passage detection part 74, and the time for the back end T of the sheet P to pass through the first sheet passage detection part 74.

As another speed measurement unit, a mechanism configured by, for example, an encoder detecting the rotation speed of the sheet discharge mechanism 76 may be employed.

As described above, the image forming apparatus 1 according to the second exemplary embodiment, the sheet P on which the image has been formed in the image forming mechanism 1A is held once in the sheet transportation mechanism 1B. Then, upon the start of pulling out the sheet P held in the sheet transportation mechanism 1B by the user, the sheet transportation mechanism 1B restarts to discharge the sheet P. Thereby, the sheet P is discharged from the image forming apparatus 1 at the time point when the user is ready to receive the sheet P. Thus, an occurrence that the user fails to receive the sheet P is reduced. By this configuration, the image forming apparatus 1, which is installed in a public facility such as a station, an airport or the like where a large number of people access, and which has a main purpose for printing map information, shop information or the like that has been requested by the user, reduces inconvenience that the user fails to receive the sheet P on which the various kinds of information has been printed and the sheet P is dropped onto the floor and left, and then the sheet P ends up in garbage.

In addition, at the time when the user starts to pull out the sheet P, the sheet P may be discharged at the sheet transportation speed according to the pull out speed at the time when the user pulls out the sheet P. It facilitates the reception of the sheet P by the user.

Note that, in the first and second exemplary embodiments, the description has been given of the image forming apparatus 1 including the image forming mechanism 1A transporting the sheet P from the lower side toward the upper side in the substantially vertical direction (an arrow direction in FIG. 1). However, the present invention is applicable to, for example, an image forming apparatus including the image forming mechanism transporting the sheet P in the substantially horizontal direction, and an image forming apparatus including the image forming mechanism transporting the sheet P from the lower side to the upper side in the oblique direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on a recording medium;
a recording medium transportation unit that transports, along a transportation route, the recording medium on which the image has been formed by the image forming unit, and that interrupts transportation operation for the recording medium in a state where one part of the recording medium is discharged from the transportation route and the other part of the recording medium is held in the transportation route;
a detection unit that detects pull out operation by a user for the recording medium containing the other part held in the transportation route by the interruption of the transportation operation by the recording medium transportation unit; and
a controller that controls the recording medium transportation unit so that the transportation operation having been interrupted is restarted, upon the detection of the pull out operation by the user by the detection unit.

2. The image forming apparatus according to claim 1, further comprising:
a speed measurement unit that measures a moving speed of the recording medium moving along the transportation route by the pull out operation by the user for the recording medium held in the transportation route; and
a speed setting unit that sets a transportation speed for the recording medium in the recording medium transportation unit in accordance with the moving speed measured by the speed measurement unit.

3. The image forming apparatus according to claim 2, wherein the speed setting unit sets at least any one of an upper limit and a lower limit of the transportation speed set in the recording medium transportation unit.

4. The image forming apparatus according to claim 1, wherein, in the recording medium transportation unit, a transportation speed for transporting the recording medium along the transportation route is set to be different from a transportation speed for the recording medium in the image forming unit.

5. The image forming apparatus according to claim 1, wherein the recording medium transportation unit includes a transportation member that performs the transportation operation for the recording medium by use of driving force transmitted from a drive source, and that is connected to the drive source via a force transmission restricting member that restricts transmission of force to the drive source from the recording medium pulled out by the pull out operation by the user.

6. The image forming apparatus according to claim 1, wherein the detection unit is arranged on a position set in advance in the transportation route, and detects the pull out operation by the user through detection of passage of a back end of the recording medium held in the transportation route.

7. The image forming apparatus according to claim 1, wherein, in a case where an image is formed on a plurality of the recording media, the image forming unit interrupts image formation on the recording media for second and subsequent pages until the detection unit detects the pull out operation by the user for the recording medium for a first page.

8. The image forming apparatus according to claim 1, wherein the image forming unit forms the image so that an image formed surface of the recording medium is located on a user's side in a case where the recording medium transportation unit interrupts the transportation operation for the recording medium in a state where the one part of the recording medium is discharged from the transportation route.

9. A recording medium transportation apparatus comprising:
a receiving port that receives a recording medium from an image forming unit that forms an image on the recording medium while transporting the recording medium;
a recording medium transportation unit that transports, along a transportation route, the recording medium received from the receiving port, and that interrupts transportation operation for the recording medium in a state where one part of the recording medium is discharged from the transportation route and the other part of the recording medium is held in the transportation route;
a detection unit that detects pull out operation by a user for the recording medium containing the other part held in the transportation route by the interruption of the transportation operation by the recording medium transportation unit; and
a controller that controls the recording medium transportation unit so that the transportation operation having been interrupted is restarted, upon the detection of the pull out operation by the user by the detection unit.

10. The recording medium transportation apparatus according to claim 9, further comprising:
a speed measurement unit that measures a moving speed of the recording medium moving along the transportation route by the pull out operation by the user for the recording medium held in the transportation route; and
a speed setting unit that sets a transportation speed for the recording medium in the recording medium transportation unit in accordance with the moving speed measured by the speed measurement unit.

11. The recording medium transportation apparatus according to claim 10, wherein the speed setting unit sets at least any one of an upper limit and a lower limit of the transportation speed set in the recording medium transportation unit.

12. The recording medium transportation apparatus according to claim 9, wherein, in the recording medium transportation unit, a transportation speed for transporting the recording medium along the transportation route is set to be different from a transportation speed for the recording medium in the image forming unit.

13. The recording medium transportation apparatus according to claim 9, wherein the recording medium transportation unit includes a transportation member that performs the transportation operation for the recording medium by use of driving force transmitted from a drive source, and that is connected to the drive source via a force transmission restricting member that restricts transmission of force to the drive source from the recording medium pulled out by the pull out operation by the user.

14. A recording medium transportation method comprising:
acquiring detection information of passage of a top end of a recording medium, from a first detection unit that detects passage of the recording medium, the recording medium having an image formed thereon and being transported along a transportation route;
causing transportation operation for the recording medium to be interrupted in a state where one part of the recording medium is discharged from the transportation route and the other part of the recording medium is held in the transportation route upon acquiring the detection information of the passage of the top end of the recording medium;
acquiring detection information that a user performs pull out operation for the recording medium, from a second detection unit that detects the pull out operation by the user for the recording medium containing the other part held in the transportation route; and
causing the transportation operation for the recording medium that has been interrupted to be restarted, upon acquiring the detection information that the user performs the pull out operation.

15. A computer readable medium storing a program causing a computer to execute a process for providing a recording medium in response to operation by a user, the process comprising:
acquiring detection information of passage of a top end of the recording medium, from a first detection unit that detects passage of the recording medium, the recording medium having an image formed thereon and being transported along a transportation route;
causing transportation operation for the recording medium to be interrupted in a state where one part of the recording medium is discharged from the transportation route and the other part of the recording medium is held in the transportation route upon acquiring the detection information of the passage of the top end of the recording medium;
acquiring detection information that the user performs pull out operation for the recording medium, from a second detection unit that detects the pull out operation by the user for the recording medium containing the other part held in the transportation route; and
causing the transportation operation for the recording medium that has been interrupted to be restarted, upon acquiring the detection information that the user performs the pull out operation.

16. The computer readable medium according to claim 15, wherein the process further comprises setting a transportation speed for the recording medium in a case where the transportation operation for the recording medium is restarted, in accordance with a moving speed of the recording medium moving along the transportation route through the pull out operation by the user for the recording medium held in the transportation route.
